(19) United States
(12) Patent Application Publication
(10) Pub. No.: US 2025/0252489 A1
(43) Pub. Date: Aug. 7, 2025

(54) METHOD AND SYSTEM FOR AUTOMATED SPECIALIZED DUE DILIGENCE FOR POLITICALLY EXPOSED PERSONS

(71) Applicant: JPMorgan Chase Bank, N.A., New York, NY (US)

(72) Inventors: Elena KOCHKINA, London (GB); Antony PAPADIMITRIOU, Manhattan, NY (US); Yulong PEI, Eindhoven (NL); Xiaomo LIU, Manhasset, NY (US); Sameena SHAH, Scarsdale, NY (US)

(73) Assignee: JPMorgan Chase Bank, N.A., New York, NY (US)

(21) Appl. No.: 18/434,378

(22) Filed: Feb. 6, 2024

(51) Int. Cl. G06Q 40/03; G06Q 50/26

(52) U.S. Cl. CPC G06Q 40/03; G06Q 50/265

(57) ABSTRACT

A method and a system for automatically performing specialized due diligence for politically exposed persons in order to evaluate risk levels associated therewith are provided. The method includes: receiving a first data set that includes a name of a person and a list of positions associated with the person; extracting, from the first data set, first additional information that relates to the person; identifying, for each respective position included in the list of positions, a corresponding category from among a set of positional categories; retrieving, from at least one publicly accessible information source, second additional information that relates to the person; analyzing each of the first data set, the first additional information, and the second additional information in order to obtain answers to questions from among a predefined set of questions; and generating a due diligence report based on a result of the analysis.

### BACKGROUND

### 1. Field of the Disclosure

This technology relates to methods and systems for automatically performing specialized due diligence for politically exposed persons in order to evaluate risk levels associated therewith in an accurate and efficient manner.

### 2. Background Information

For many organizations such as financial institutions or banks, Know Your Customer (KYC) operations are a regular part of a normal business protocol. KYC operations and screening service teams may be tasked with performing specialized due diligence for politically exposed persons to evaluate the risk levels associated with them.

This process typically involves members of the team manually researching information about each politically exposed position that a particular person holds or has ever held. The questions being researched include the type of position; in which country the person is located; what are the start and end dates of this position; whether the position is still active; whether the position is appointed, elected, born into, or hired into; and role responsibilities associated with the position. However, when performed manually, this process is laborious and time-consuming.

Accordingly, there is a need for a method for automatically performing specialized due diligence for politically exposed persons in order to evaluate risk levels associated therewith in an accurate and efficient manner.

### SUMMARY

The present disclosure, through one or more of its various aspects, embodiments, and/or specific features or sub-components, provides, inter alia, various systems, servers, devices, methods, media, programs, and platforms for methods and systems for automatically performing specialized due diligence for politically exposed persons in order to evaluate risk levels associated therewith in an accurate and efficient manner.

According to an aspect of the present disclosure, a method for automatically performing specialized due diligence with respect to a person is provided. The method is implemented by at least one processor. The method includes: receiving, by the at least one processor, a first data set that includes a name of a first person and a list of positions associated with the first person; extracting, from the first data set by the at least one processor, first additional information that relates to the first person; identifying, by the at least one processor for each respective position included in the list of positions, a corresponding category from among a predetermined set of positional categories; retrieving, by the at least one processor from at least one publicly accessible information source, second additional information that relates to the first person; analyzing, by the at least one processor, each of the first data set, the first additional information, and the second additional information in order to obtain at least one answer to at least one question from among a predetermined set of questions; and generating, by the at least one processor, a report based on a result of the analyzing.

The predetermined set of questions may include a first question that relates to how an association between a particular person and a particular position began, a second question that relates to a start date and an end date for the association between the particular person and the particular position, a third question that relates to whether the particular person remains active with respect to the particular position, a fourth question that relates to a country that is associated with both the particular person and the particular position, and a fifth question that relates to responsibilities of the particular person with respect to the particular position.

For the first question that relates to how an association between a particular person and a particular position began, the at least one answer may include at least one from among an appointment, an election, a birthright, and a hiring.

The analyzing may include applying a first artificial intelligence (AI)-based algorithm to the first data set, the first additional information, and the second additional information.

The predetermined set of positional categories may include a first category that relates to national legislative officials, a second category that relates to executives of a state-owned enterprise, a third category that relates to heads of state, a fourth category that relates to military leaders, a fifth category that relates to national cabinet members, a sixth category that relates to sub-national level positions, a seventh category that relates to other politically exposed positions, and an eighth category that relates to positions that are not politically exposed.

The at least one publicly accessible information source may include at least one from among a page on a corporate website that is associated with at least one position included in the list of positions and a page on a news outlet website that includes information about the first person.

The method may further include performing a document translation with respect to the second additional information in order to generate an English language version of the second additional information.

The analyzing may include: extracting portions of the first data set, the first additional information, and the second additional information that relate to the at least one question; merging the extracted portions into a first merged set of data; providing the first merged set of data and the at least one question as inputs to a large language model; and submitting a request to the large language model to generate the at least one answer to the at least one question.

The first data set may include at least one from among data that is provided in a HyperText Markup Language (HTML) format, data that is provided in a Portable Document Format (PDF) format, data that is provided in a JavaScript Object Notation (JSON) format, and data that is provided in an Extensible Markup Language (XML) format.

According to another exemplary embodiment, a computing apparatus for automatically performing specialized due diligence with respect to a person is provided. The computing apparatus includes a processor; a memory; and a communication interface coupled to each of the processor and the memory. The processor is configured to: receive, via the communication interface, a first data set that includes a name of a first person and a list of positions associated with the first person; extract, from the first data set, first additional information that relates to the first person; identify, for each respective position included in the list of positions, a corresponding category from among a predetermined set of positional categories; retrieve, from at least one publicly accessible information source, second additional information that relates to the first person; analyze each of the first data set, the first additional information, and the second additional information in order to obtain at least one answer to at least one question from among a predetermined set of questions; and generate a report based on a result of the analysis.

The predetermined set of questions may include a first question that relates to how an association between a particular person and a particular position began, a second question that relates to a start date and an end date for the association between the particular person and the particular position, a third question that relates to whether the particular person remains active with respect to the particular position, a fourth question that relates to a country that is associated with both the particular person and the particular position, and a fifth question that relates to responsibilities of the particular person with respect to the particular position.

For the first question that relates to how an association between a particular person and a particular position began, the at least one answer may include at least one from among an appointment, an election, a birthright, and a hiring.

The processor may be further configured to perform the analysis by applying a first artificial intelligence (AI)-based algorithm to the first data set, the first additional information, and the second additional information.

The predetermined set of positional categories may include a first category that relates to national legislative officials, a second category that relates to executives of a state-owned enterprise, a third category that relates to heads of state, a fourth category that relates to military leaders, a fifth category that relates to national cabinet members, a sixth category that relates to sub-national level positions, a seventh category that relates to other politically exposed positions, and an eighth category that relates to positions that are not politically exposed.

The at least one publicly accessible information source may include at least one from among a page on a corporate website that is associated with at least one position included in the list of positions and a page on a news outlet website that includes information about the first person.

The processor may be further configured to perform a document translation with respect to the second additional information in order to generate an English language version of the second additional information.

The processor may be further configured to: extract portions of the first data set, the first additional information, and the second additional information that relate to the at least one question; merge the extracted portions into a first merged set of data; provide the first merged set of data and the at least one question as inputs to a large language model; and submit a request to the large language model to generate the at least one answer to the at least one question.

The first data set may include at least one from among data that is provided in an HTML format, data that is provided in a PDF format, data that is provided in a JSON format, and data that is provided in an XML format.

According to yet another exemplary embodiment, a non-transitory computer readable storage medium storing instructions for automatically performing specialized due diligence with respect to a person is provided. The storage medium includes executable code which, when executed by a processor, causes the processor to: receive a first data set that includes a name of a first person and a list of positions associated with the first person; extract, from the first data set, first additional information that relates to the first person; identify, for each respective position included in the list of positions, a corresponding category from among a predetermined set of positional categories; retrieve, from at least one publicly accessible information source, second additional information that relates to the first person; analyze each of the first data set, the first additional information, and the second additional information in order to obtain at least one answer to at least one question from among a predetermined set of questions; and generate a report based on a result of the analysis.

The predetermined set of questions may include a first question that relates to how an association between a particular person and a particular position began, a second question that relates to a start date and an end date for the association between the particular person and the particular position, a third question that relates to whether the particular person remains active with respect to the particular position, a fourth question that relates to a country that is associated with both the particular person and the particular position, and a fifth question that relates to responsibilities of the particular person with respect to the particular position.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for automatically performing specialized due diligence for politically exposed persons in order to evaluate risk levels associated therewith in an accurate and efficient manner.

FIG. 4 is a flowchart of an exemplary process for implementing a method for automatically performing specialized due diligence for politically exposed persons in order to evaluate risk levels associated therewith in an accurate and efficient manner.

FIG. 5 is an illustration of a workflow of a manual process for performing specialized due diligence for politically exposed persons.

FIG. 6 is an illustration of an automated workflow of a method for automatically performing specialized due diligence for politically exposed persons in order to evaluate risk levels associated therewith in an accurate and efficient manner, according to an exemplary embodiment.

FIG. 7 is an illustration of an extraction algorithm that is executable as a part of a method for automatically performing specialized due diligence for politically exposed persons in order to evaluate risk levels associated therewith in an accurate and efficient manner, according to an exemplary embodiment.

FIG. 8 is an illustration of a categorization algorithm that is executable as another part of a method for automatically performing specialized due diligence for politically exposed persons in order to evaluate risk levels associated therewith in an accurate and efficient manner, according to an exemplary embodiment.

FIG. 9 is an illustration of a public information discovery algorithm that is executable as another part of a method for automatically performing specialized due diligence for politically exposed persons in order to evaluate risk levels associated therewith in an accurate and efficient manner, according to an exemplary embodiment.

FIG. 10 is an illustration of a document translation algorithm that is executable as another part of a method for automatically performing specialized due diligence for politically exposed persons in order to evaluate risk levels associated therewith in an accurate and efficient manner, according to an exemplary embodiment.

FIG. 11 is an illustration of a question answering algorithm that is executable as another part of a method for automatically performing specialized due diligence for politically exposed persons in order to evaluate risk levels associated therewith in an accurate and efficient manner, according to an exemplary embodiment.

FIG. 12 is an illustration of a template-based entry generation algorithm that is executable as another part of a method for automatically performing specialized due diligence for politically exposed persons in order to evaluate risk levels associated therewith in an accurate and efficient manner, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

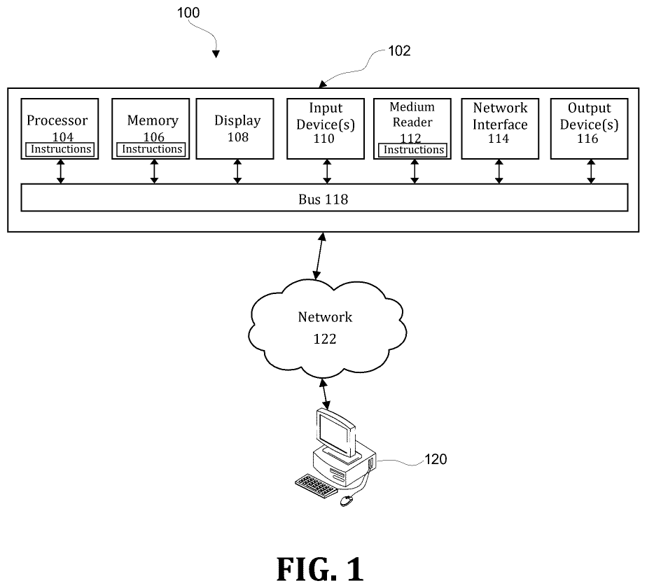

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for automatically performing specialized due diligence for politically exposed persons in order to evaluate risk levels associated therewith in an accurate and efficient manner.

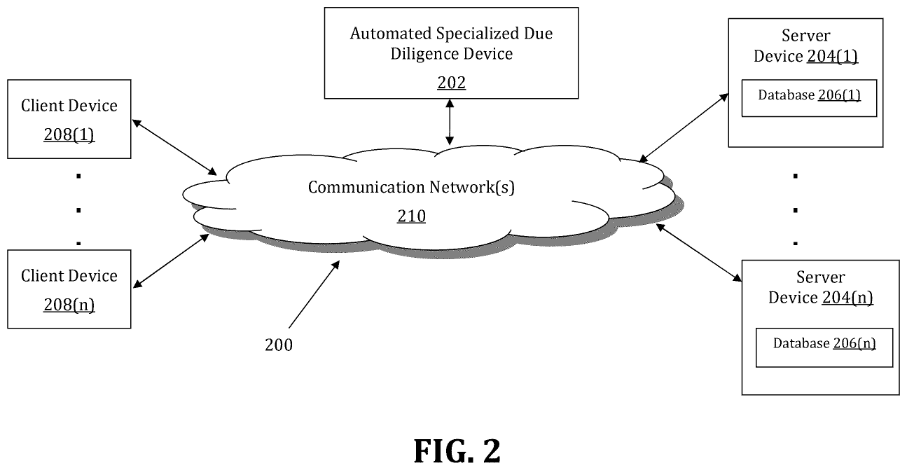

Referring to FIG. 2, a schematic of an exemplary network environment 200 for implementing a method for automatically performing specialized due diligence for politically exposed persons in order to evaluate risk levels associated therewith in an accurate and efficient manner is illustrated. In an exemplary embodiment, the method is executable on any networked computer platform, such as, for example, a personal computer (PC).

The method automatically performing specialized due diligence for politically exposed persons in order to evaluate risk levels associated therewith in an accurate and efficient manner may be implemented by an Automated Specialized Due Diligence (ASDD) device 202. The ASDD device 202 may be the same or similar to the computer system 102 as described with respect to FIG. 1. The ASDD device 202 may store one or more applications that can include executable instructions that, when executed by the ASDD device 202, cause the ASDD device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ASDD device 202 itself, may be located in virtual server(s) running in a cloud-based computing environment rather than being tied to one or more specific physical network computing devices. Also, the application(s) may be running in one or more virtual machines (VMs) executing on the ASDD device 202. Additionally, in one or more embodiments of this technology, virtual machine(s) running on the ASDD device 202 may be managed or supervised by a hypervisor.

In the network environment 200 of FIG. 2, the ASDD device 202 is coupled to a plurality of server devices 204(1)-204(n) that hosts a plurality of databases 206(1)-206(n), and also to a plurality of client devices 208(1)-208(n) via communication network(s) 210. A communication interface of the ASDD device 202, such as the network interface 114 of the computer system 102 of FIG. 1, operatively couples and communicates between the ASDD device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ASDD device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and ASDD devices that efficiently implement a method for automatically performing specialized due diligence for politically exposed persons in order to evaluate risk levels associated therewith in an accurate and efficient manner.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The ASDD device 202 may be a standalone device or integrated with one or more other devices or apparatuses, such as one or more of the server devices 204(1)-204(n), for example. In one particular example, the ASDD device 202 may include or be hosted by one of the server devices 204(1)-204(n), and other arrangements are also possible. Moreover, one or more of the devices of the ASDD device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the ASDD device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to politically exposed persons and information that relates to documents used for performing due diligence.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the ODO device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the ASDD device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the ASDD device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the ASDD device 202, the server devices 204(1)-204(n), or the client devices 208(1)-208(n), for example, may be configured to operate as virtual instances on the same physical machine. In other words, one or more of the ASDD device 202, the server devices 204(1)-204(n), or the client devices 208(1)-208(n) may operate on the same physical device rather than as separate devices communicating through communication network(s) 210. Additionally, there may be more or fewer ASDD devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

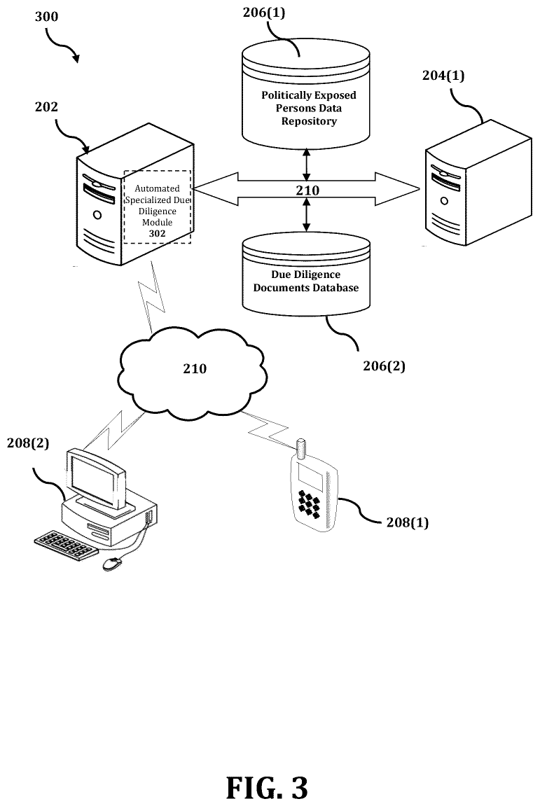

The ASDD device 202 is described and illustrated in FIG. 3 as including an automated specialized due diligence module 302, although it may include other rules, policies, modules, databases, or applications, for example. As will be described below, the automated specialized due diligence module 302 is configured to implement a method for automatically performing specialized due diligence for politically exposed persons in order to evaluate risk levels associated therewith in an accurate and efficient manner.

An exemplary process 300 for implementing a mechanism for automatically performing specialized due diligence for politically exposed persons in order to evaluate risk levels associated therewith in an accurate and efficient manner by utilizing the network environment of FIG. 2 is illustrated as being executed in FIG. 3. Specifically, a first client device 208(1) and a second client device 208(2) are illustrated as being in communication with ASDD device 202. In this regard, the first client device 208(1) and the second client device 208(2) may be “clients” of the ASDD device 202 and are described herein as such. Nevertheless, it is to be known and understood that the first client device 208(1) and/or the second client device 208(2) need not necessarily be “clients” of the ASDD device 202, or any entity described in association therewith herein. Any additional or alternative relationship may exist between either or both of the first client device 208(1) and the second client device 208(2) and the ASDD device 202, or no relationship may exist.

Further, ASDD device 202 is illustrated as being able to access a politically exposed persons data repository 206(1) and a due diligence documents database 206(2). The automated specialized due diligence module 302 may be configured to access these databases for implementing a method for automatically performing specialized due diligence for politically exposed persons in order to evaluate risk levels associated therewith in an accurate and efficient manner.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the ASDD device 202 via broadband or cellular communication. Of course, these embodiments are merely exemplary and are not limiting or exhaustive.

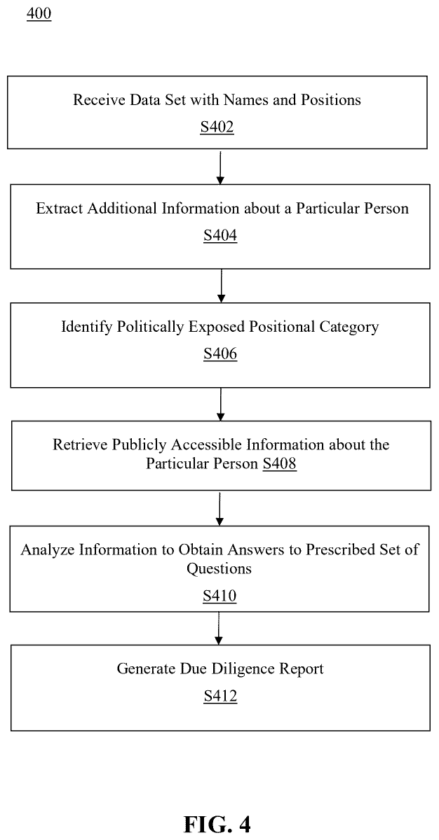

Upon being started, the automated specialized due diligence module 302 executes a process for automatically performing specialized due diligence for politically exposed persons in order to evaluate risk levels associated therewith in an accurate and efficient manner. An exemplary process for automatically performing specialized due diligence for politically exposed persons in order to evaluate risk levels associated therewith in an accurate and efficient manner is generally indicated at flowchart 400 in FIG. 4.

In process 400 of FIG. 4, at step S402, the automated specialized due diligence module 302 receives a data set that includes one or more names of persons for whom specialized due diligence is to be performed and corresponding lists of positions that are associated with those persons. In an exemplary embodiment, each person that is named in the received data set is a candidate politically exposed person. In an exemplary embodiment, the data set may include data that is provided in a HyperText Markup Language (HTML) format, data that is provided in a Portable Document Format (PDF) format, data that is provided in a JavaScript Object Notation (JSON) format, and data that is provided in an Extensible Markup Language (XML) format.

At step S404, the automated specialized due diligence module 302 extracts first additional information about each of the persons from the data set. In an exemplary embodiment, the types of information to be extracted may include any one or more of the following: information that relates to how an association between a particular person and a particular position began; information that relates to a start date and an end date for the association between the particular person and the particular position, information that relates to whether the particular person remains active with respect to the particular position; information that relates to a country that is associated with both the particular person and the particular position; and/or information that relates to responsibilities of the particular person with respect to the particular position.

At step S406, the automated specialized due diligence module 302 identifies a respective category for each position with which each person is associated. In an exemplary embodiment, the category is included in predetermined set of positional categories that includes each of the following: a first category that relates to national legislative officials; a second category that relates to executives of a state-owned enterprise; a third category that relates to heads of state; a fourth category that relates to military leaders; a fifth category that relates to national cabinet members; a sixth category that relates to sub-national level positions; a seventh category that relates to other politically exposed positions; and an eighth category that relates to positions that are not politically exposed.

At step S408, the automated specialized due diligence module 302 retrieves publicly accessible information about each person. In an exemplary embodiment, the internet may be used as a resource for retrieving such publicly accessible information. For example, the source of the publicly accessible information may include either or both of a page on a corporate website that relates to a position associated with one of the persons and/or a page on a news outlet website that includes information about one of the persons. In an exemplary embodiment, when the publicly accessible information that has been retrieved includes information that is in a foreign language, the automated specialized due diligence module 302 may perform a document translation in order to generate an English-language version of the information.

At step S410, the automated specialized due diligence module 302 analyzes the information that has been received in step S402, extracted in step S404, and retrieved in step S408 in order to obtain answers to a prescribed set of questions. In an exemplary embodiment, the prescribed set of questions includes a first question that relates to how an association between a particular person and a particular position began; a second question that relates to a start date and an end date for the association between the particular person and the particular position; a third question that relates to whether the particular person remains active with respect to the particular position; a fourth question that relates to a country that is associated with both the particular person and the particular position; and a fifth question that relates to responsibilities of the particular person with respect to the particular position. Regarding the first question that relates to how an association between a particular person and a particular position began, the answer may include any one or more of the following: an appointment; an election; a birthright; and/or a hiring.

At step S412, the automated specialized due diligence module 302 uses a result of the analysis performed in step S410 to generate a respective due diligence report for each person included in the data set received in step S402. In an exemplary embodiment, the analysis performed in step S410 and/or the generation of the due diligence report may be performed by applying an artificial intelligence (AI)-based algorithm to the data set received in step S402, the information extracted in step S404, and the information retrieved in step S408.

In an exemplary embodiment, a method and a system for automatically performing specialized due diligence for politically exposed persons in order to evaluate risk levels associated therewith in an accurate and efficient manner is provided. This approach automates the answering of Know Your Customer (KYC)-relevant questions about politically exposed individuals in order to save time and costs that are associated with more laborious and time-consuming conventional manual approach to this process. This is achieved by using AI algorithms and techniques.

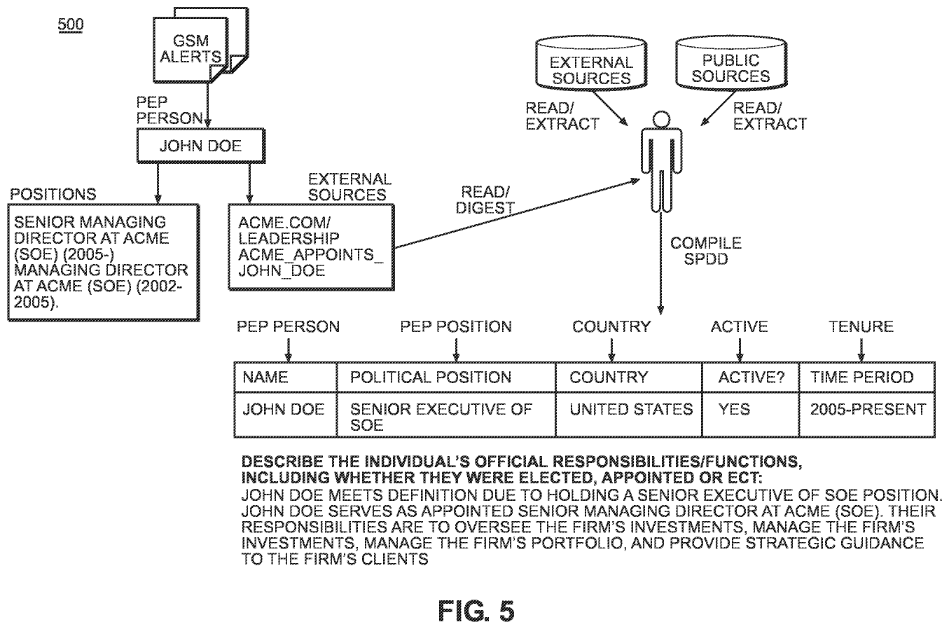

FIG. 5 is an illustration 500 of a workflow of a manual process for performing specialized due diligence for politically exposed persons. As shown in FIG. 5, a Global Sanctions Manager (GSM) module may provide a name of a person, a list of positions associated with the person, and a list of external sources of information about the person. However, the remainder of the conventional process is performed by an individual that is responsible for 1) reading and digesting the information received from the GSM module; 2) reading and extracting relevant information from external sources identified in the information received from GSM and also relevant information that is available via public sources; and 3) compiling a specialized due diligence (abbreviated as SpDD in FIG. 5) report. As also shown in FIG. 5, the SpDD report may include a table that has several columns, including a first column for the name of the person, a second column for the political position associated with the person, a third column for the country associated with the person and the position, a fourth column for whether or not the person remains active in the position, and a fifth column for a tenure/time period of the person's association with the position. The SpDD report may also include a brief description of the person's official responsibilities and functions and also an explanation of how the person became associated with the position.

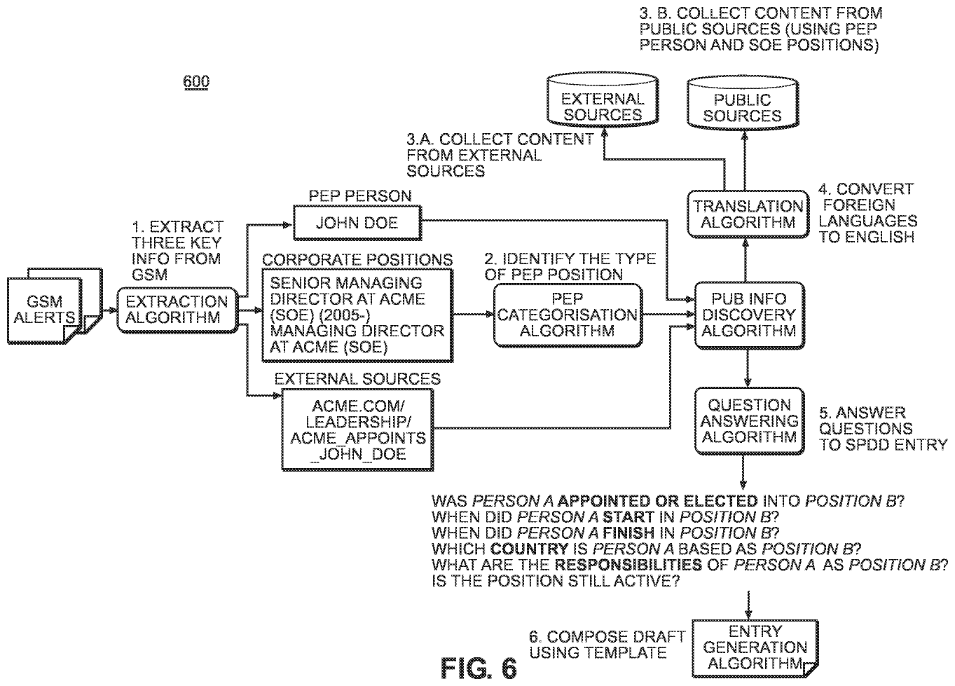

FIG. 6 is an illustration 600 of an automated workflow of a method for automatically performing specialized due diligence for politically exposed persons in order to evaluate risk levels associated therewith in an accurate and efficient manner, according to an exemplary embodiment. As shown in FIG. 6, the automated workflow is initiated by receiving a data set from the GSM module. After this information is received, the workflow uses an extraction algorithm to extract three key pieces of information from the received data set: a name of a person, a list of positions associated with the person, and a list of external sources of information about the person. In some circumstances, if available in the received data set, additional information such as country, start date, and end date may also be extracted. Then, the workflow uses a categorization algorithm to assign each position from the list of positions to a category that identifies a corresponding type of politically exposed position.

Referring again to FIG. 6, the workflow then uses a public information discovery algorithm to collect content from both the external sources identified by the extraction algorithm and also from public sources. The workflow then uses a translation algorithm to convert any foreign language information that has been collected into an English-language version thereof. The workflow then proceeds to a question answering algorithm in order to answer questions that are relevant to the specialized due diligence process. Lastly, after the answers to the questions have been determined, the workflow uses an entry generation algorithm to generate a due diligence report. In an exemplary embodiment, the report is generated by using a template that has a prescribed format.

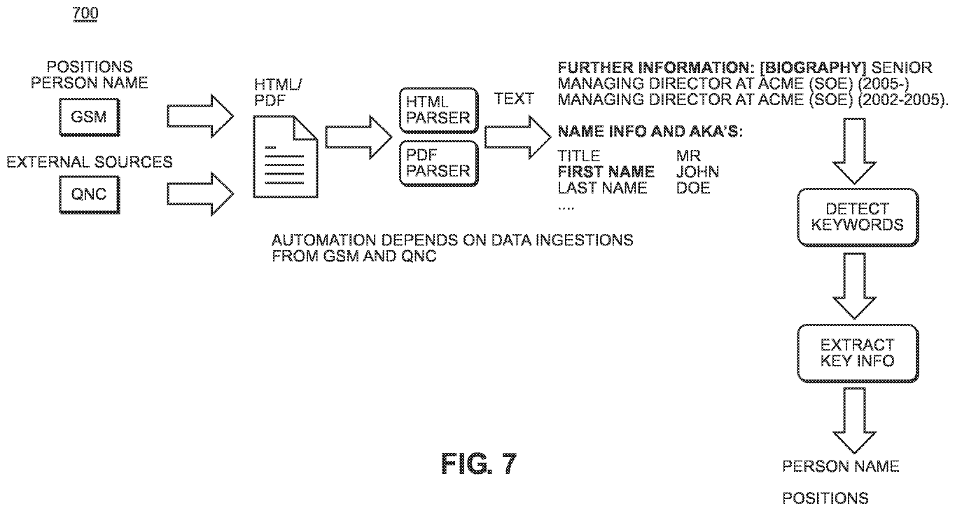

FIG. 7 is an illustration 700 of an extraction algorithm that is executable as a part of a method for automatically performing specialized due diligence for politically exposed persons in order to evaluate risk levels associated therewith in an accurate and efficient manner, according to an exemplary embodiment. As shown in FIG. 7, the data set that is received from the GSM module and/or data that is received from a Quick Name Check (QNC) module may be in any one or more of an HTML format, a PDF format, a JSON format, and an XML format, and the extraction algorithm may use an HTML parser and a PDF parser to extract information therefrom. The extraction algorithm then detects keywords and uses these keywords to extract key information, such as names of politically exposed persons, positions that are associated with such persons, and external sources of information about such persons.

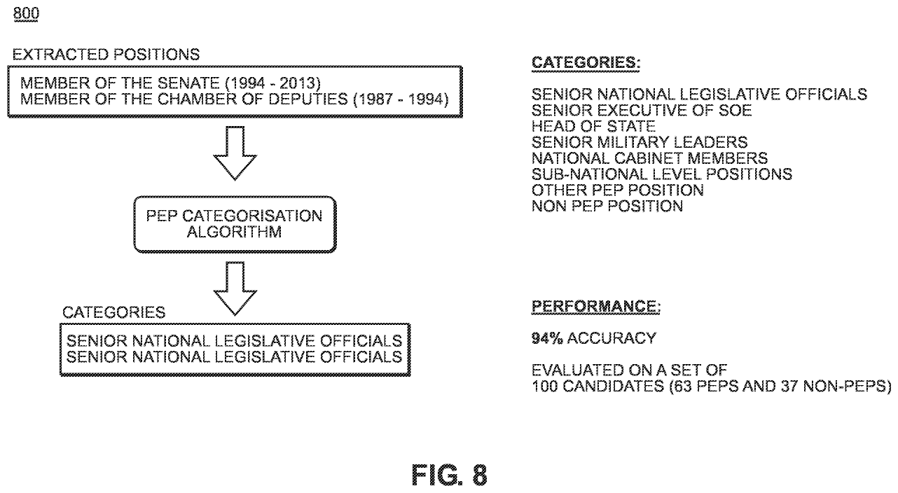

FIG. 8 is an illustration 800 of a categorization algorithm that is executable as another part of a method for automatically performing specialized due diligence for politically exposed persons in order to evaluate risk levels associated therewith in an accurate and efficient manner, according to an exemplary embodiment. As shown in FIG. 8, the categorization algorithm takes the list of positions extracted by the extraction algorithm as an input and then determines a category for each such position as an output. In an exemplary embodiment, the category is selected from a predetermined list of categories, including the following: a first category that relates to national legislative officials; a second category that relates to executives of a state-owned enterprise; a third category that relates to heads of state; a fourth category that relates to military leaders; a fifth category that relates to national cabinet members; a sixth category that relates to sub-national level positions; a seventh category that relates to other politically exposed positions; and an eighth category that relates to positions that are not politically exposed.

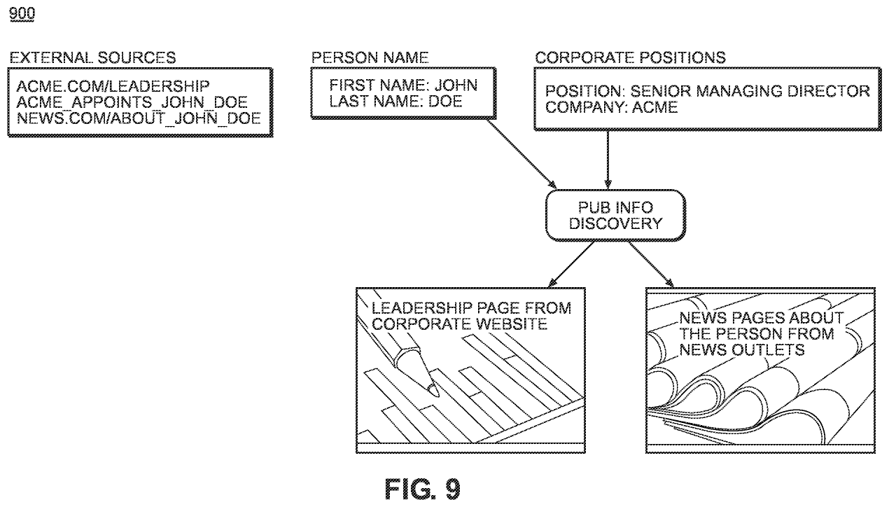

FIG. 9 is an illustration 900 of a public information discovery algorithm that is executable as another part of a method for automatically performing specialized due diligence for politically exposed persons in order to evaluate risk levels associated therewith in an accurate and efficient manner, according to an exemplary embodiment. As shown in FIG. 9, the public information discovery algorithm uses the information extracted by the extraction algorithm to determine where to search for additional information about the person. As a result, in an exemplary embodiment, the public information discovery algorithm may use any one or more of the external sources extracted by the extraction algorithm, a leadership page from a corporate website, and/or news pages about the person and the associated company from news outlets as a source for additional information.

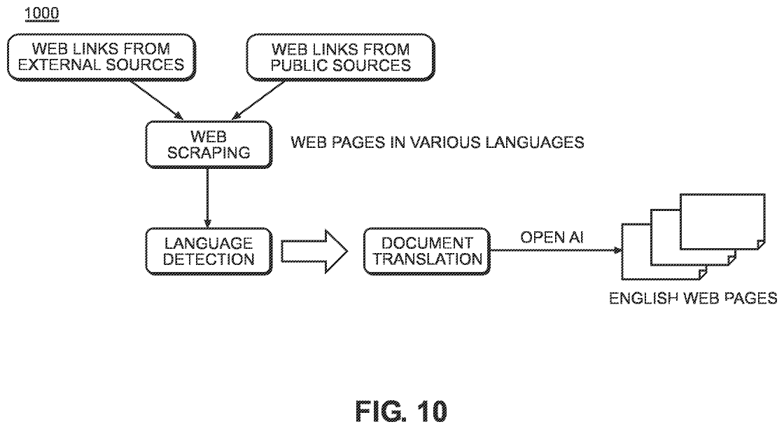

FIG. 10 is an illustration 1000 of a document translation algorithm that is executable as another part of a method for automatically performing specialized due diligence for politically exposed persons in order to evaluate risk levels associated therewith in an accurate and efficient manner, according to an exemplary embodiment. As shown in FIG. 10, when information obtained by the public information discovery algorithm is in a foreign language, the document translation algorithm first performs a language detection operation to determine which foreign language is applicable, and then performs a document translation operation in order to generate an English-language version of the information.

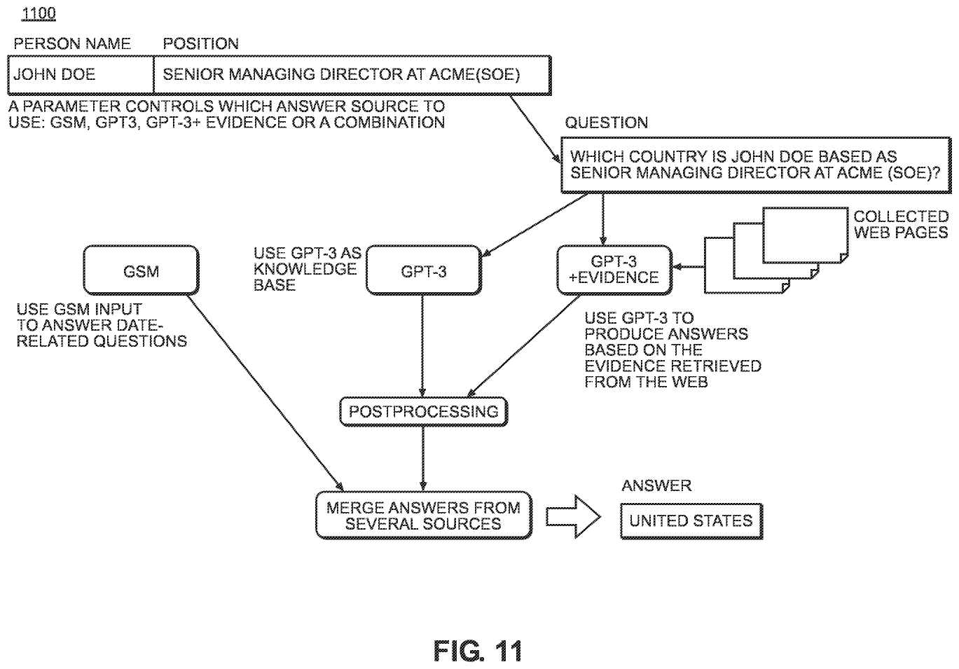

FIG. 11 is an illustration 1100 of a question answering algorithm that is executable as another part of a method for automatically performing specialized due diligence for politically exposed persons in order to evaluate risk levels associated therewith in an accurate and efficient manner, according to an exemplary embodiment. As shown in FIG. 11, the question answering algorithm uses information obtained by the extraction algorithm, the categorization algorithm, and the public information discovery algorithm to obtain answers to a prescribed set of questions. In an exemplary embodiment, this information may be merged into a single merged set of data, which may then be provided as an input to a large language model, together with the prescribed set of questions, in order to obtain answers to the questions as an output of the large language model. For example, the large language model may be a ChatGPT model or a GPT-3 model.

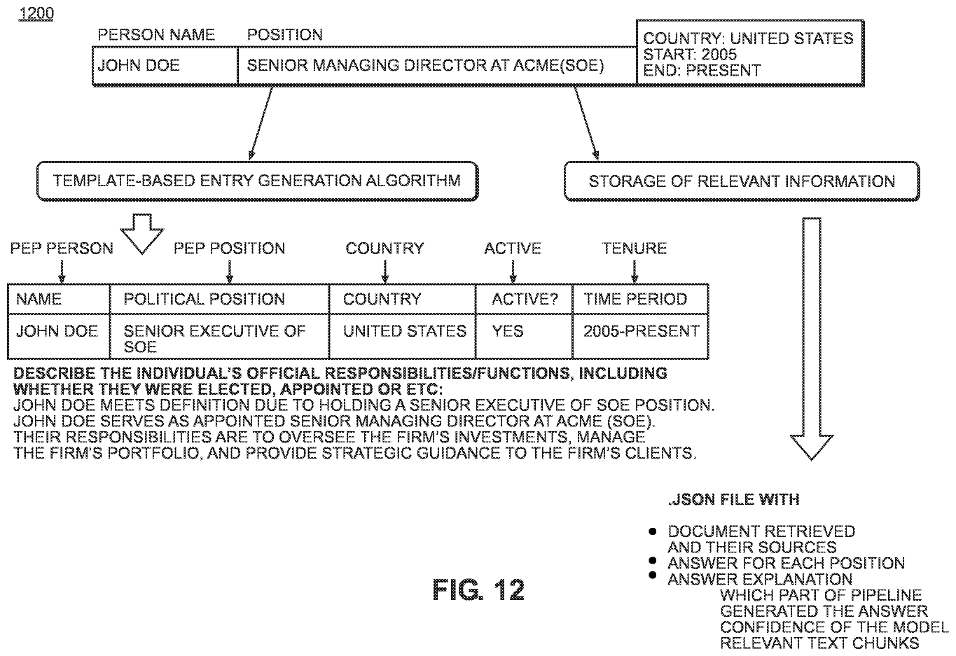

FIG. 12 is an illustration 1200 of a template-based entry generation algorithm that is executable as another part of a method for automatically performing specialized due diligence for politically exposed persons in order to evaluate risk levels associated therewith in an accurate and efficient manner, according to an exemplary embodiment. As shown in FIG. 12, the template-based entry generation algorithm receives the output of the question answering algorithm and uses this output to generate a specialized due diligence report that has a prescribed format that is based on a template. In an exemplary embodiment, the specialized due diligence report includes a table that has several columns, including a first column for the name of the person, a second column for the political position associated with the person, a third column for the country associated with the person and the position, a fourth column for whether or not the person remains active in the position, and a fifth column for a tenure/time period of the person's association with the position. The specialized due diligence report may also include a brief description of the person's official responsibilities and functions and also an explanation of how the person became associated with the position. In an exemplary embodiment, there is also a storage of relevant information operation by which the following information is stored for future reference: documents retrieved and their sources; answers for each question per position; and answer explanations, including which part of the pipeline generated the answer, confidence of the model, and relevant text chunks.

In an exemplary embodiment, the system for automatically performing specialized due diligence for politically exposed persons in order to evaluate risk levels associated therewith may also include any one or more of several additional components. One such additional component is a source screening component that screens the quality of the sources used to produce the answers. First, the Uniform Resource Locator (URL) of the source is used for extracting a domain of the source. Then, the system performs a look-up operation of this domain in a trustworthy database that contains information about domain type and quality, such as, for example, News or Blog, etc., and quality tier. In addition, the source screening component may perform an operation by which a determination is made as to whether or not the domain is present in a predefined whitelist and/or blacklist of domains. The restrictions of the quality of the sources used can be controlled by the use of a predetermined parameter.

A second such additional component is an answer confidence estimation component that is usable for reporting a confidence rating for each answer produced as being either High, Medium, or Low. Each tier has its own requirements based on the quality of the sources used, agreement between sources, and confidence of the model.

A third such additional component is an answer explanation component that obtains explanatory information regarding how a particular answer is produced. The explanatory information may include any one or more of the following: 1) for each person, links of the webpages identified as being relevant sources in the public information discovery module; 2) for each person, the corresponding text retrieved from those sources identified as being relevant; 3) for each person, screenshots, update dates, and other metadata where available; 4) for each person, a reliability tier of each source domain; 5) for each answer, a corresponding answer contribution from each of three answer sources (e.g., LLM, LLM plus evidence, and GSM); 6) for each answer, the source of the final answer and which sources are in agreement among the three answer sources; 7) for each answer, document chunks from the retrieved documents deemed as being of significant relevance to the particular answer, and for each document chunk, a corresponding confidence score produced by the model associated with the confidence of the answer extracted from that chunk; and 8) for each answer, a position of the answer in the document chunk and/or a position of the most relevant phrase or sentence.

Accordingly, with this technology, a process for automatically performing specialized due diligence for politically exposed persons in order to evaluate risk levels associated therewith in an accurate and efficient manner is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for automatically performing specialized due diligence with respect to a person, the method being implemented by at least one processor, the method comprising:
receiving, by the at least one processor, a first data set that includes a name of a first person and a list of positions associated with the first person;
extracting, from the first data set by the at least one processor, first additional information that relates to the first person;
identifying, by the at least one processor for each respective position included in the list of positions, a corresponding category from among a predetermined set of positional categories;
retrieving, by the at least one processor from at least one publicly accessible information source, second additional information that relates to the first person;
analyzing, by the at least one processor, each of the first data set, the first additional information, and the second additional information in order to obtain at least one answer to at least one question from among a predetermined set of questions; and
generating, by the at least one processor, a report based on a result of the analyzing.

2. The method of claim 1, wherein the predetermined set of questions includes a first question that relates to how an association between a particular person and a particular position began, a second question that relates to a start date and an end date for the association between the particular person and the particular position, a third question that relates to whether the particular person remains active with respect to the particular position, a fourth question that relates to a country that is associated with both the particular person and the particular position, and a fifth question that relates to responsibilities of the particular person with respect to the particular position.

3. The method of claim 2, wherein for the first question that relates to how an association between a particular person and a particular position began, the at least one answer includes at least one from among an appointment, an election, a birthright, and a hiring.

4. The method of claim 1, wherein the analyzing comprises applying a first artificial intelligence (AI)-based algorithm to the first data set, the first additional information, and the second additional information.

5. The method of claim 1, wherein the predetermined set of positional categories includes a first category that relates to national legislative officials, a second category that relates to executives of a state-owned enterprise, a third category that relates to heads of state, a fourth category that relates to military leaders, a fifth category that relates to national cabinet members, a sixth category that relates to sub-national level positions, a seventh category that relates to other politically exposed positions, and an eighth category that relates to positions that are not politically exposed.

6. The method of claim 1, wherein the at least one publicly accessible information source includes at least one from among a page on a corporate website that is associated with at least one position included in the list of positions and a page on a news outlet website that includes information about the first person.

7. The method of claim 1, further comprising performing a document translation with respect to the second additional information in order to generate an English language version of the second additional information.

8. The method of claim 1, wherein the analyzing comprises:
extracting portions of the first data set, the first additional information, and the second additional information that relate to the at least one question;
merging the extracted portions into a first merged set of data;
providing the first merged set of data and the at least one question as inputs to a large language model; and
submitting a request to the large language model to generate the at least one answer to the at least one question.

9. The method of claim 1, wherein the first data set includes at least one from among data that is provided in a HyperText Markup Language (HTML) format, data that is provided in a Portable Document Format (PDF) format, data that is provided in a JavaScript Object Notation (JSON) format, and data that is provided in an Extensible Markup Language (XML) format.

10. A computing apparatus for automatically performing specialized due diligence with respect to a person, the computing apparatus comprising:
a processor;
a memory; and
a communication interface coupled to each of the processor and the memory,
wherein the processor is configured to:
receive, via the communication interface, a first data set that includes a name of a first person and a list of positions associated with the first person;
extract, from the first data set, first additional information that relates to the first person;
identify, for each respective position included in the list of positions, a corresponding category from among a predetermined set of positional categories;
retrieve, from at least one publicly accessible information source, second additional information that relates to the first person;
analyze each of the first data set, the first additional information, and the second additional information in order to obtain at least one answer to at least one question from among a predetermined set of questions; and
generate a report based on a result of the analysis.

11. The computing apparatus of claim 10, wherein the predetermined set of questions includes a first question that relates to how an association between a particular person and a particular position began, a second question that relates to a start date and an end date for the association between the particular person and the particular position, a third question that relates to whether the particular person remains active with respect to the particular position, a fourth question that relates to a country that is associated with both the particular person and the particular position, and a fifth question that relates to responsibilities of the particular person with respect to the particular position.

12. The computing apparatus of claim 11, wherein for the first question that relates to how an association between a particular person and a particular position began, the at least one answer includes at least one from among an appointment, an election, a birthright, and a hiring.

13. The computing apparatus of claim 10, wherein the processor is further configured to perform the analysis by applying a first artificial intelligence (AI)-based algorithm to the first data set, the first additional information, and the second additional information.

14. The computing apparatus of claim 10, wherein the predetermined set of positional categories includes a first category that relates to national legislative officials, a second category that relates to executives of a state-owned enterprise, a third category that relates to heads of state, a fourth category that relates to military leaders, a fifth category that relates to national cabinet members, a sixth category that relates to sub-national level positions, a seventh category that relates to other politically exposed positions, and an eighth category that relates to positions that are not politically exposed.

15. The computing apparatus of claim 10, wherein the at least one publicly accessible information source includes at least one from among a page on a corporate website that is associated with at least one position included in the list of positions and a page on a news outlet website that includes information about the first person.

16. The computing apparatus of claim 10, wherein the processor is further configured to perform a document translation with respect to the second additional information in order to generate an English language version of the second additional information.

17. The computing apparatus of claim 10, wherein the processor is further configured to:
extract portions of the first data set, the first additional information, and the second additional information that relate to the at least one question;
merge the extracted portions into a first merged set of data;
provide the first merged set of data and the at least one question as inputs to a large language model; and
submit a request to the large language model to generate the at least one answer to the at least one question.

18. The computing apparatus of claim 10, wherein the first data set includes at least one from among data that is provided in a HyperText Markup Language (HTML) format, data that is provided in a Portable Document Format (PDF) format, data that is provided in a JavaScript Object Notation (JSON) format, and data that is provided in an Extensible Markup Language (XML) format.

19. A non-transitory computer readable storage medium storing instructions for automatically performing specialized due diligence with respect to a person, the storage medium comprising executable code which, when executed by a processor, causes the processor to:
receive a first data set that includes a name of a first person and a list of positions associated with the first person;
extract, from the first data set, first additional information that relates to the first person;
identify, for each respective position included in the list of positions, a corresponding category from among a predetermined set of positional categories;
retrieve, from at least one publicly accessible information source, second additional information that relates to the first person;
analyze each of the first data set, the first additional information, and the second additional information in order to obtain at least one answer to at least one question from among a predetermined set of questions; and
generate a report based on a result of the analysis.

20. The storage medium of claim 19, wherein the predetermined set of questions includes a first question that relates to how an association between a particular person and a particular position began, a second question that relates to a start date and an end date for the association between the particular person and the particular position, a third question that relates to whether the particular person remains active with respect to the particular position, a fourth question that relates to a country that is associated with both the particular person and the particular position, and a fifth question that relates to responsibilities of the particular person with respect to the particular position.
